(19) United States
(12) Patent Application Publication
(10) Pub. No.: US 2010/0161246 A1
(43) Pub. Date: Jun. 24, 2010

(54) FAULT DETECTION SYSTEM AND METHOD

(75) Inventors: Mohit Verma, Decatur, IL (US); James W. Reinhart, Decatur, IL (US); Jon P. White, Monticello, IL (US); Christopher A. Pollum, Peoria, IL (US); Ricky J. Heller, Canton, IL (US); David W. Holthaus, Monticello, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Peoria, IL (US)

(21) Appl. No.: 12/340,348

(22) Filed: Dec. 19, 2008

(51) Int. Cl. G01B 5/28

(52) U.S. Cl. 702/39

(57) ABSTRACT

A fault detection system for a fastener (224) in a machine (100) includes an ultrasonic sensor (404) that is integrated with the fastener and capable of emitting an ultrasonic signal (506) that travels through a length of the fastener (224). The ultrasonic sensor (404) receives a returning ultrasonic signal (506) and a processor (512) calculates a travel time between an emission of the ultrasonic signal (506) and a receipt of the returning ultrasonic signal (506). The processor (512) calculates an actual length (L) of the fastener (224) based on the travel time (510), compares the actual length (L) with a predetermined length of the fastener (224), and emits a wireless signal (519) to an electronic controller (612) of the machine (100) that is indicative of a structural state of the fastener (224).

### TECHNICAL FIELD

This patent disclosure relates generally to systems and methods for detection of failures in machine components and, more particularly, to early detection of cracks and/or other failures in components of machine or vehicle steering systems in real time during operation.

### BACKGROUND

Heavy machinery, such as off-highway trucks, are commonly used in mining, heavy construction, quarrying, and other applications. Such applications typically subject various systems and components of such machinery to high stresses and loading. Such loading can cause cracks and/or other types of structural damage to various components. As is often the case, such heavy machinery operates on rough terrain, which can cause failures in components of the steering and suspension systems of the machine. Diagnosing such failures can often become a time consuming task given the large number of components associated with such systems.

To correct such failures, machines are removed from service, which increases the cost of ownership to the machine operators. In order to avoid unforeseen machine downtime due to failures, periodic inspections of numerous bolted joints are often performed. Such inspections are often visual and include limited diagnostic tests. The most typical diagnostic test is known as “tapping,” which entails striking a bolt with a hammer or another device to induce a vibration or sound. The sound is subjectively evaluated by the technician performing the test for its quality and pitch, in an effort to determine whether the bolt is structurally sound.

Such periodic testing often requires the removal of the machine from service. Moreover, the testing methods employed are not always effective in detecting certain types of failures, for example, hairline cracks, in the components being tested. Further, certain types of failures can occur quickly and cannot be detected in a periodic test. Such failures often occur during operation of a machine in the field, thus requiring removal of the machine for service and towing of the machine into a service facility. This increases the cost of the repair and downtime of the machine.

### SUMMARY

The disclosure describes, in one aspect, a machine having a fault detection system for detecting a structural failure of a fastener in real time. The fastener connects a first component of the machine with a second component of the machine, and includes an ultrasonic sensor disposed at one end of the fastener. The ultrasonic sensor is integrated with the fastener and capable of emitting an ultrasonic signal that travels through a length of the fastener. The ultrasonic sensor is further capable of receiving a returning ultrasonic signal. An ultrasonic reflector is disposed at another end of the fastener and adapted to reflect the ultrasonic signal, thus sending the returning ultrasonic signal to the ultrasonic receiver. A processor receives signals from the ultrasonic emitter and the ultrasonic receiver that are indicative of a travel time between an emission of the ultrasonic signal and a receipt of the returning ultrasonic signal. The processor then calculates an actual length of the fastener based on the travel time, compares the actual length with the length of the fastener, which is predetermined, and emits a wireless signal to an electronic controller of the machine that is indicative of a structural state of the fastener.

In another aspect, the disclosure describes a fault detection system for detecting a structural failure, in real time, of a fastener connecting a first component of a machine with a second component of the machine. The fault detection system includes an ultrasonic sensor that is integrated with the fastener. An ultrasonic emitter that is integrated with the ultrasonic sensor emits an ultrasonic signal that travels through a length of the fastener and is reflected by an ultrasonic reflector. The reflected signal returns to an ultrasonic receiver that is integrated with the ultrasonic sensor and capable of receiving the returning ultrasonic signal. A processor receives signals from the ultrasonic emitter and the ultrasonic receiver that are indicative of a travel time between an emission of the ultrasonic signal and a receipt of the returning ultrasonic signal. The processor calculates an actual length of the fastener based on the travel time, compares the actual length with a predetermined length of the fastener, and emits a wireless signal. The wireless signal is indicative of a structural state of the fastener and is received by an electronic controller of the machine.

In yet another aspect, the disclosure describes a method for diagnosing a structural condition of a fastener in real time during operation of a machine. The method includes emitting an ultrasonic signal from an ultrasonic sensor that is operably associated with the fastener and disposed at one end thereof. The ultrasonic signal is reflected by an ultrasonic reflector that is operably associated with the fastener and disposed at another end thereof. The reflected ultrasonic signal is received by the ultrasonic sensor, which calculates an actual length of the fastener based on a time between the emission and receipt of the ultrasonic signal. The ultrasonic sensor provides a wireless signal to an electronic controller of the machine that is indicative of a structural state of the fastener. The electronic controller determines whether a fault condition has occurred based on the wireless signal.

### BRIEF DESCRIPTION OF THE DRAWINGS

FIG. 1 is a side view of a machine in accordance with the disclosure.

FIG. 2 is an outline view of a steering system for a machine in accordance with the disclosure.

FIG. 3 is a side view of a ball stud for use in a steering system for a machine in accordance with the disclosure.

FIG. 4 is a section view of a ball stud having a crack detection device in accordance with the disclosure.

FIG. 5 is a block diagram of a crack detection system installed in a ball stud in accordance with the disclosure.

FIG. 6 is a block diagram of a machine having a ball stud crack detection system in accordance with the disclosure.

### DETAILED DESCRIPTION

This disclosure relates to early failure detection in bolted joints of machines and, more particularly to crack detection systems using ultrasonic technology that diagnose failures in bolted joints between moving parts in real time during operation of the machine. The embodiments described herein include systems and methods for diagnosing cracking or excessive strain conditions in ball studs used in steering systems. Even though ball studs in a steering system are used as examples in the description, the systems and methods disclosed herein are applicable to other types of fasteners used in different applications. The disclosure generally provides for real time detection of structural issues associated with joints in a machine that are subjected to loading and stresses during operation. When an abnormal condition is detected, the disclosure provides for an early warning system that informs the operator of a potentially impending failure such that the abnormal condition may be repaired or rectified before it disables the machine.

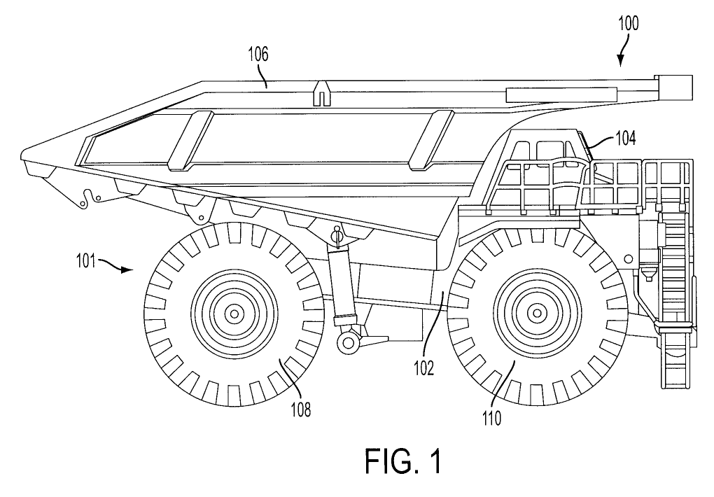

FIG. 1 illustrates a side view of a machine 100. One example of the machine 100 is an off-highway truck 101 such as those used for construction, mining, or quarrying. In the description that follows, this example illustrates the various arrangements that can be used on machines having steering systems that include steering actuators connected to steering knuckles. The steering knuckles in the illustrated embodiments include steering arms that are interconnected by steering rods. As can be appreciated, any other vehicle having a steering system that includes steering arms interconnected by ball studs or other fastener types can benefit from the advantages described herein. The term “machine,” therefore, is used to generically describe any machine having at least one wheel that is steerable.

A side view of the off-highway truck 101 is shown in FIG. 1. The off-highway truck 101 includes a chassis 102 that supports an operator cab 104 and a bucket 106. The bucket 106 is pivotally connected to the chassis 102 and is arranged to carry a payload when the off-highway truck 101 is in service. An operator occupying the operator cab 104 can control the motion and the various functions of the off-highway truck 101. The chassis 102 supports various drive system components. These drive system components are capable of driving a set of drive wheels 108 to propel the off-highway truck 101. A set of idle wheels 110 can steer such that the off-highway truck 101 can move in any direction. Even though the off-highway truck 101 includes a rigid chassis with powered wheels for motion and steerable wheels for steering, one can appreciate that other machine configurations can be used. For example, such configurations may include articulated chassis with one or more driven wheels.

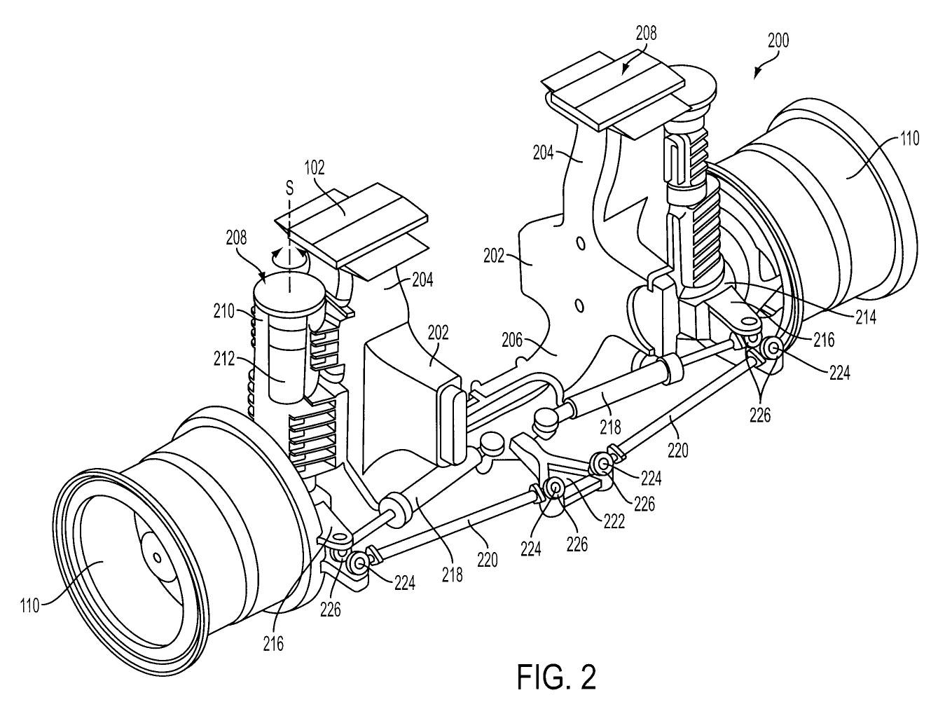

An outline view of a steering system 200 for the off-highway truck 101 (FIG. 1) is shown in FIG. 2. The steering system 200 is connected to the chassis 102 and operates to turn the idle wheels 110, which are represented here as wheel rims with their respective tires removed for illustration. The steering system 200 is connected to frame rails 202 belonging to the chassis 102. The chassis 102 forms two posts 204 that are connected on one end thereof to one another by a cross-member 206, forming a U-shape. Two suspension arrangements 208 are connected, one each, to the two posts 204. Each of the two suspension arrangements 208 allows each idle wheel 110 to independently move vertically during operation when travelling over uneven terrain.

Each of the two suspension arrangements 208 includes a frame portion 210 that is connected to a respective post 204. The frame portion 210 is a hollow tubular member that slidably surrounds a wheel portion 212. During operation, the wheel portion 212 is capable of dampened movement relative to the frame portion 210 by use of a spring (not shown) and/or a motion damper (not shown). A steering knuckle 214 is rotatably connected at one end of the wheel portion 212 for each of the two suspension arrangements 208. Each steering knuckle 214 can rotate about a respective steering axis, S, when the idle wheels 110 are steering, and can further move vertically following the motion of the wheel portion 212 relative to the frame portion 210.

Each steering knuckle 214 rotatably supports one of the idle wheels 110 via a bearing (not shown). A steering arm 216 is formed on each steering knuckle 214. The steering arm 216 is rigidly connected to the steering knuckle 214 or, alternatively, integrated therewith such that it turns in unison with the steering knuckle 214 when the idle wheels 110 are turning. One end of a linear actuator 218 is connected to each steering arm 216. In one embodiment, two linear actuators 218 are used to steer the steering knuckles 214 but a single steering actuator may be used. The linear actuators 218 presented here are hydraulically actuated, but other types of linear actuators, or alternatively, rotational actuators, may be used.

When the idle wheels 110 are steered, one of the two linear actuators 218 extends while the other retracts. Such operation pushes the steering arms 216 to turn both steering knuckles 214 in the same direction. Two tie rods 220 rotatably interconnect the two steering arms 216 to ensure proper alignment of the two idle wheels 110 during a turn. In one embodiment, a Y-bracket 222 interconnects the two tie rods to the cross-member 206. The steering system 200 is capable of accommodating independent vertical motion of the idle wheels 110 relative to the chassis 102. Hence, the pivoting connections between the steering arms 216 and both the linear actuators 218 and tie rods 220 must provide for lateral angular rotation.

In one embodiment, the pivoting connections employ a ball-and-socket connection arrangement, which includes a ball stud 224 connected to a socket 226. In the embodiment shown in FIG. 2, for example, eight such connections are arranged in pairs, with one disposed on either side of each of the two linear actuators 218 and each of the two tie rods 220.

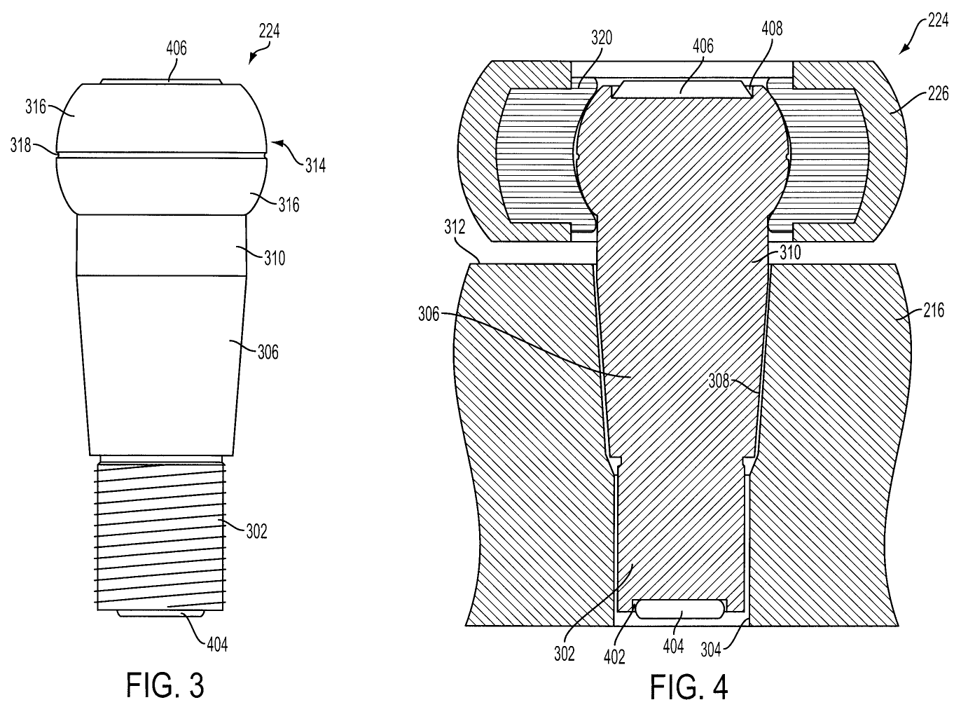

A side view of a ball stud 224 is shown in FIG. 3, and a section view of the ball stud 224 installed into the steering arm 216 and connected to a socket 226 is shown in FIG. 4. In one embodiment, the ball stud 224 includes a threaded segment 302 that threadably engages a threaded opening 304 formed in the steering arm 216. A conical shaft segment 306 is formed along the ball stud 224 and disposed adjacent to the threaded segment 302. The conical shaft segment 306 matingly engages a conical bore 308 formed in the steering arm 216. The mating between the conical shaft segment 306 and the conical bore 308 provides positioning and alignment between the ball stud 224 and the steering arm 216.

A cylindrical neck segment 310 is formed in the ball stud 224 adjacent to the conical shaft segment 306. The cylindrical neck segment 310 at least partially protrudes out of the conical bore 308 to provide a height difference between a corresponding surface 312 of the steering arm 216 and a spherical segment 314 of the ball stud 224. This height difference provides clearance for the pivoting motion between the ball stud 224 and the socket 226.

In one embodiment, the spherical segment 314 includes two hemispherical surfaces 316 disposed on either side of a lubrication channel 318. The two hemispherical surfaces 316 matingly connect with a concave washer 320 that is slidably disposed thereon. The concave washer 320 provides the “socket” feature of the ball-and-socket joint arrangement between the ball stud 224 and the socket 226. As can be appreciated, the lubrication channel 318 is optional and can provide improved retention of lubricant between the spherical segment 314 and the concave washer 320.

In one embodiment, a sensor cavity 402 is formed at or adjacent to an end of the ball stud 224. An ultrasonic sensor 404 is disposed within the sensor cavity 402 and operably contacts the ball stud 224. The ultrasonic sensor 404 cooperates with an ultrasonic reflector 406 that is disposed within a reflector cavity 408, which is formed at or adjacent to an opposite end of the ball stud 224. The ultrasonic sensor 404 is located adjacent to and partially within the threaded segment 302, while the ultrasonic reflector 406 is located adjacent to the spherical segment 314. The relative positioning of these components, however, may be rearranged. For example, the ultrasonic sensor 404 may be positioned adjacent to the spherical segment 314 while the ultrasonic reflector 406 may be located adjacent to the threaded segment 302. Alternatively, both the ultrasonic sensor 404 and the ultrasonic reflector 406 may be positioned at diametrically opposite locations along the cylindrical neck segment 310 or the conical shaft segment 306, but other suitable locations may be used.

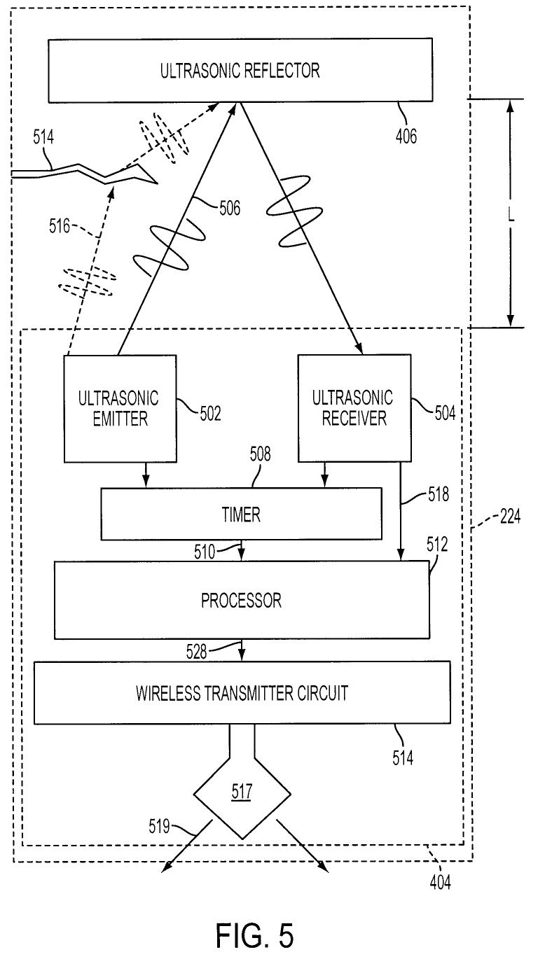

A block diagram of the ball stud 224 illustrating the operation of the ultrasonic sensor 404 and the ultrasonic reflector 406 is shown in FIG. 5. The ball stud 224 is represented diagrammatically in this figure for purpose of description. The ultrasonic sensor 404 includes an ultrasonic emitter 502 and an ultrasonic receiver 504. The ultrasonic emitter 502 generates an ultrasonic signal or vibration 506, which is denoted in FIG. 5 with a solid lined open headed arrow.

The vibration 506 travels or is transmitted within the core material that makes up the ball stud 224 at a known wavelength and a known speed. When the vibration 506 reaches the ultrasonic reflector 406, it is reflected back through the ball stud 224 and is received by the ultrasonic receiver 504. Information about the time between emitting the vibration 506 by the ultrasonic emitter 502 and receiving the vibration 506 at the ultrasonic receiver 504 is determined by a timer function 508, which communicates with the ultrasonic emitter 502 and the ultrasonic receiver 504. The timer function 508 provides a time signal 510 to a processor 512, which time signal 510 is indicative of the total time required for a vibration 506 emitted by the ultrasonic emitter 502 to travel twice through the ball stud 224.

The processor 512 includes appropriate logic that calculates a length, L, of the ball stud 224 based on the travel time and speed of the vibration 506, and compares the length L to a known, predetermined length of the ball stud 224. Based on such comparison, the processor 512 may determine the extent of stretching, if any, that the ball stud 224 has undergone. Such stretching may be attributed to loading, bending, or any other physical strain condition that the ball stud 224 may undergo during service.

In addition to sensing strain and bending of the ball stud 224 during service, cracks or other structural conditions may be sensed. For example, the presence of a crack 513, which is shown qualitatively as a set of angled lines, may distort or redirect an incoming vibration 516 that is emitted by the ultrasonic emitter 502. Such redirection or distortion may cause the incoming vibration 516 to travel a longer distance or to fail to reach the ultrasonic receiver 504 entirely or in part, thus decreasing its intensity. The ultrasonic receiver 504 may provide additional information 518 to the processor 512 about the intensity of the incoming vibration 516. The processor 512 may analyze this additional information 518 to determine whether any physical anomalies, such as cracks, have caused distortion that affects the intensity of the incoming vibration 516.

A signal 528 is provided by the processor 512 to a wireless transmitter circuit 514. The signal 528 is indicative of the determination of the processor 512 about the physical condition of the ball stud 224. In one embodiment, the signal 528 may be in a first state when there are no faults detected by the processor 512, and in a second state when a fault has been detected. Such faults include strain or bending of the ball stud 224, the existence or formation of cracks in the ball stud 224, and so forth.

The wireless transmitter circuit 514, which in one embodiment is integrated with the ultrasonic sensor 404 and contains appropriate circuitry that allows for wireless transmission of information, includes an antenna 517. The antenna 517 operates to generate a wireless signal 519 that is indicative of the state of a signal 528 provided by the processor 512.

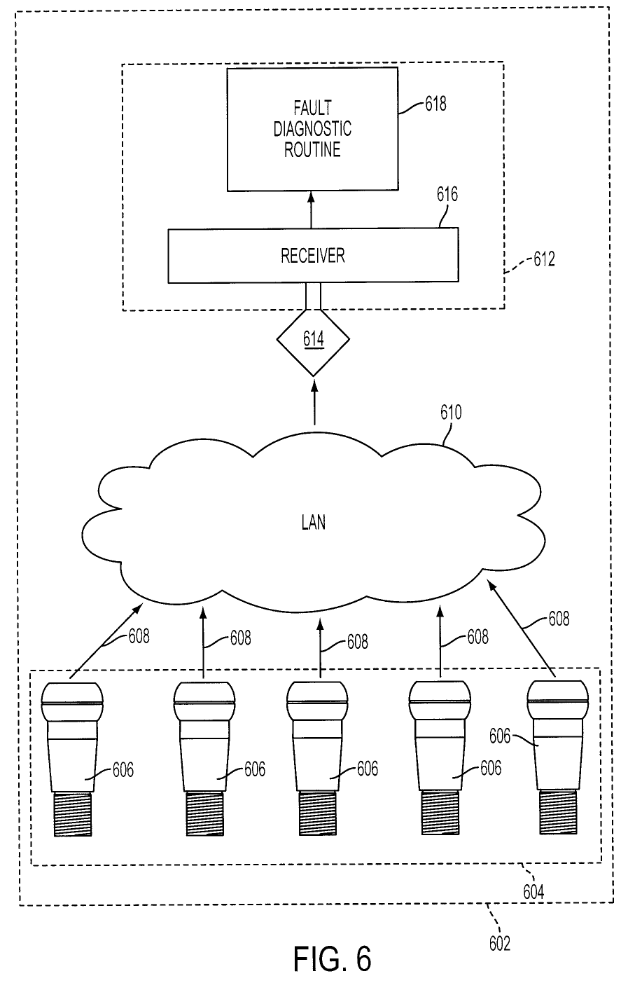

A block diagram of a ball stud monitoring system for a machine 602 is shown in FIG. 6. The machine 602 may be the off-highway truck 101 (FIG. 1) or any other machine having bolted joints whose structural condition is monitored in accordance with this disclosure. The machine 602 includes a steering system 604, for example, the steering system 200 shown in FIG. 2, which includes a plurality of ball studs 606. Even though five ball studs are shown, fewer or more ball studs may be included in the steering system 604 or any other system of the machine having similar joints. Each of the plurality of ball studs 606 includes appropriate sensors having electronic circuits that can diagnose the structural condition of each of the plurality of ball studs 606 in real time during operation. For example, each of the plurality of ball studs 606 may include an ultrasonic sensor and receiver such as those included in the ball stud 224 shown in FIG. 5.

During operation, each of the plurality of ball studs 606 provides a wireless signal 608 that is indicative of the respective condition thereof. Hence, a plurality of signals that includes each wireless signal 608 may be present in the machine and collected. In one embodiment, the collection of wireless signals 608 can be provided within a local area network (LAN) 610 that encompasses all signals generated by the plurality of ball studs 606. The LAN 610 is generated and monitored by an electronic controller 612 of the machine 602. The electronic controller 612 includes an antenna 614 that receives information indicative of the state of each of the plurality of ball studs 606. Information collected by the antenna 614 is provided to a receiver 616. Collection of the wireless signals 608 by the receiver 616 can be accomplished directly between the antenna 614 and each of the plurality of ball studs 606, or such information may alternatively be aggregated by the receiver 616 from the LAN 610. In one embodiment, the receiver 616 includes appropriate functionality that can distinguish between each wireless signal 608, for example, where each wireless signal 608 is emitted at a different radio frequency or a different carrier frequency interposed on a radio signal.

Information about the state of each of the plurality of ball studs 606 received by the receiver 616 is provided to a fault diagnostic routine 618. The fault diagnostic routine 618 operates to determine whether a fault has occurred in any one of the plurality of ball studs 606 based on a respective wireless signal 608 received at the receiver 616. The fault diagnostic routine 618 may provide information locally to an operator of the machine or remotely to a base station. Such information indicates the presence or absence of a fault within one or more of the plurality of ball studs 606 such that, for example, the machine 602 may be scheduled for service. Such functionality is advantageous because any indication of a fault occurring within one of the plurality of ball studs 606 is provided in real time during operation of the machine 602. Hence, failures that might have otherwise not been diagnosed until their severity caused a removal of the machine from service can be detected early in the failure process and be rectified in a shorter time and at a lower cost than was previously attainable.

### INDUSTRIAL APPLICABILITY

The present disclosure is applicable to any type of machine having bolted joints that are exposed to stress or other loading during service. The present disclosure provides for diagnosing failures in ball studs disposed in steering systems for machines or, in general, in fasteners used as part of bolted joints or on moving components of a machine in real time. Early failure diagnosis enables timely service, which may lead to lower cost of ownership and reduced down time.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A machine having a fault detection system for detecting a structural failure, in real time, of a fastener connecting a first component of the machine with a second component of the machine, comprising:
an ultrasonic sensor disposed at one end of the fastener, the ultrasonic sensor being integrated with the fastener, capable of emitting an ultrasonic signal that travels through a length of the fastener, and capable of receiving a returning ultrasonic signal;
an ultrasonic reflector disposed at another end of the fastener, the ultrasonic reflector adapted to reflect the ultrasonic signal and send the returning ultrasonic signal to the ultrasonic sensor;
a processor operably associated with the ultrasonic sensor and adapted to receive signals that are indicative of a travel time between an emission of the ultrasonic signal and a receipt of the returning ultrasonic signal;
the processor being disposed to:
calculate an actual length of the fastener based on the travel time;
compare the actual length with the length of the fastener, which is predetermined; and
emit a wireless signal to an electronic controller of the machine that is indicative of a structural state of the fastener in real time.

2. The machine of claim 1, wherein the machine further includes a steering system, wherein the first component and the second component are each at least one of a steering arm, an actuator, a tie rod, and a bracket, and wherein the fastener is a ball stud that includes a conical shaft segment that aligns the ball stud with a mating conical bore formed in the steering arm.

3. The machine of claim 1, wherein the fastener forms a sensor cavity, and wherein the ultrasonic sensor is disposed in the sensor cavity.

4. The machine of claim 1, wherein the fastener forms a reflector cavity, and wherein the ultrasonic reflector is disposed in the reflector cavity.

5. The machine of claim 1, wherein the structural state of the fastener includes strain, which is imparted onto the fastener by stressing of the fastener during service, and cracks, which are caused by excessive strain of the fastener during service.

6. The machine of claim 1, wherein the ultrasonic sensor includes a wireless transmitter and an antenna, the wireless transmitter disposed to generate the wireless signal and the antenna disposed to emit the wireless signal.

7. The machine of claim 1, wherein the electronic controller includes a receiver disposed to receive the wireless signal.

8. The machine of claim 7, wherein the electronic controller further includes a fault diagnostic routine that is disposed to diagnose the structural state of the fastener based on the wireless signal.

9. A fault detection system for detecting a structural failure in real time of a fastener connecting a first component of a machine with a second component of the machine, comprising:
an ultrasonic sensor disposed at one end of the fastener, the ultrasonic sensor being integrated with the fastener;
an ultrasonic emitter integrated with the ultrasonic sensor and capable of emitting an ultrasonic signal that travels through a length of the fastener;
an ultrasonic receiver integrated with the ultrasonic sensor and capable of receiving a returning ultrasonic signal;
an ultrasonic reflector disposed at another end of the fastener, the ultrasonic reflector adapted to reflect the ultrasonic signal and send the returning ultrasonic signal to the ultrasonic receiver;
a processor receiving signals from the ultrasonic emitter and the ultrasonic receiver that are indicative of a travel time between an emission of the ultrasonic signal and a receipt of the returning ultrasonic signal;
the processor being disposed to:
calculate an actual length of the fastener based on the travel time;
compare the actual length with the length of the fastener, which is predetermined; and
emit a wireless signal to an electronic controller of the machine that is indicative of a structural state of the fastener in real time.

10. The fault detection system of claim 9, wherein the fault detection system further includes a steering system, wherein the first component and the second component are each at least one of a steering arm, an actuator, a tie rod, and a bracket, and wherein the fastener is a ball stud that includes a conical shaft segment that aligns the ball stud with a mating conical bore formed in the steering arm.

11. The fault detection system of claim 9, wherein the fastener forms a sensor cavity, and wherein the ultrasonic sensor is disposed in the sensor cavity.

12. The fault detection system of claim 9, wherein the fastener forms a reflector cavity, and wherein the ultrasonic reflector is disposed in the reflector cavity.

13. The fault detection system of claim 9, wherein the structural state of the fastener includes strain, which is imparted onto the fastener by stressing of the fastener during service, and cracks, which are caused by excessive strain of the fastener during service.

14. The fault detection system of claim 9, wherein the ultrasonic sensor includes a wireless transmitter and an antenna, the wireless transmitter disposed to generate the wireless signal and the antenna disposed to emit the wireless signal.

15. The fault detection system of claim 9, wherein the electronic controller includes a receiver disposed to receive the wireless signal.

16. The fault detection system of claim 15, wherein the electronic controller further includes a fault diagnostic routine that is disposed to diagnose the structural state of the fastener based on the wireless signal.

17. A method for diagnosing in real time a structural condition of a fastener disposed in a machine during operation, the method comprising:
emitting an ultrasonic signal from an ultrasonic sensor operably associated with the fastener and disposed at one end thereof;
reflecting the ultrasonic signal with an ultrasonic reflector operably associated with the fastener and disposed at another end thereof;
receiving the ultrasonic signal in the ultrasonic sensor;
calculating an actual length of the fastener based on a time between the emission and receipt of the ultrasonic signal;
providing a wireless signal from the ultrasonic sensor to an electronic controller of the machine that is indicative of a structural state of the fastener; and
determining whether a fault condition has occurred in the electronic controller based on the wireless signal in real time.

18. The method of claim 17, further comprising providing a plurality of wireless signals, each of the plurality of wireless signals being provided by one of a plurality of fasteners disposed in the machine.

19. The method of claim 17, further including determining an intensity of the ultrasonic signal, and setting the structural state for the fastener that is indicative of a crack being present when the intensity of the ultrasonic signal is below an expected value.

20. The method of claim 17, further including providing an alert at least one of locally and remotely when the electronic controller determines that the fault condition has occurred.
